(19) United States
(12) Patent Application Publication
(10) Pub. No.: US 2013/0110944 A1
(43) Pub. Date: May 2, 2013

(54) GENERATING AN ELECTRONIC MESSAGE DURING A BROWSING SESSION

(71) Applicants: James Ketcham, Shelbyville, KY (US); Kenric Taylor, San Francisco, CA (US); Daniel Dreilinger, San Francisco, CA (US)

(72) Inventors: James Ketcham, Shelbyville, KY (US); Kenric Taylor, San Francisco, CA (US); Daniel Dreilinger, San Francisco, CA (US)

(73) Assignee: CBS Interactive, Inc.

(21) Appl. No.: 13/484,149

(22) Filed: May 30, 2012

Related U.S. Application Data
(63) Continuation of application No. 13/283,244, filed on Oct. 27, 2011.

(51) Int. Cl. G06F 15/16

(52) U.S. Cl. 709/206

(57) ABSTRACT

A computer system for generating an electronic message for a user includes a memory and a processing circuit. The memory is configured to store a plurality of user identifiers, each user identifier having an electronic message address associated with the user. The processing circuit is configured to receive user interaction data relating to user interaction with first content on a web site during a web browsing session, identify a keyword associated with the content interacted with by the user, store the keyword in a memory device, select second content using the stored keyword, generate an electronic message comprising the second content, and transmit the electronic message over a network interface to the user during the web browsing session.

### CROSS-REFERENCE TO RELATED PATENT APPLICATIONS

This application is a Continuation of U.S. application Ser. No. 13/283,244, filed Oct. 27, 2011, incorporated herein by reference in its entirety.

### BACKGROUND OF THE INVENTION

Content-based web sites are used by many to read, learn, comment, research and study. Content-based web sites can also offer newsletters, white papers, or other supplemental content to further engage the user. Users can sign up for the newsletters when visiting the site, for example when seeing an overlay or pop-up window offering a subscription to the newsletter.

### BRIEF DESCRIPTION OF THE DRAWINGS

FIG. 1 is a block diagram of a system for generating an electronic message during a browsing session, according to an exemplary embodiment;

FIG. 2 is a flow diagram of a system and method for generating an electronic message during a browsing session, according to an exemplary embodiment;

FIG. 3 is a flow chart of a method of generating an electronic message during a browsing session, according to an exemplary embodiment.

FIG. 4 is a flow chart of a method of generating an electronic message at a time, according to an exemplary embodiment.

### DETAILED DESCRIPTION OF THE PREFERRED EMBODIMENTS

Some embodiments described herein provide an electronic message to a user during a browsing session with content related to the content that the user is or has been browsing. Some embodiments described herein provide an electronic message to a user at a time of day that a user is typically browsing a web site, with content that may relate to content typically browsed by the user. Some embodiments described herein may provide relevant offers to people who are actively engaging with web sites in a timely fashion, thus increasing the chance of a purchase or lead conversion. Some embodiments described herein may show the user an offer that is generated based on the content they are consuming on the web site which results in an increase in acceptance of these offers and avoids burning out a user by showing offers that they are not interested in. Some embodiments may result in an increase in conversions while decreasing churn on marketing lists by showing only relevant offers based on a user's activities to the user.

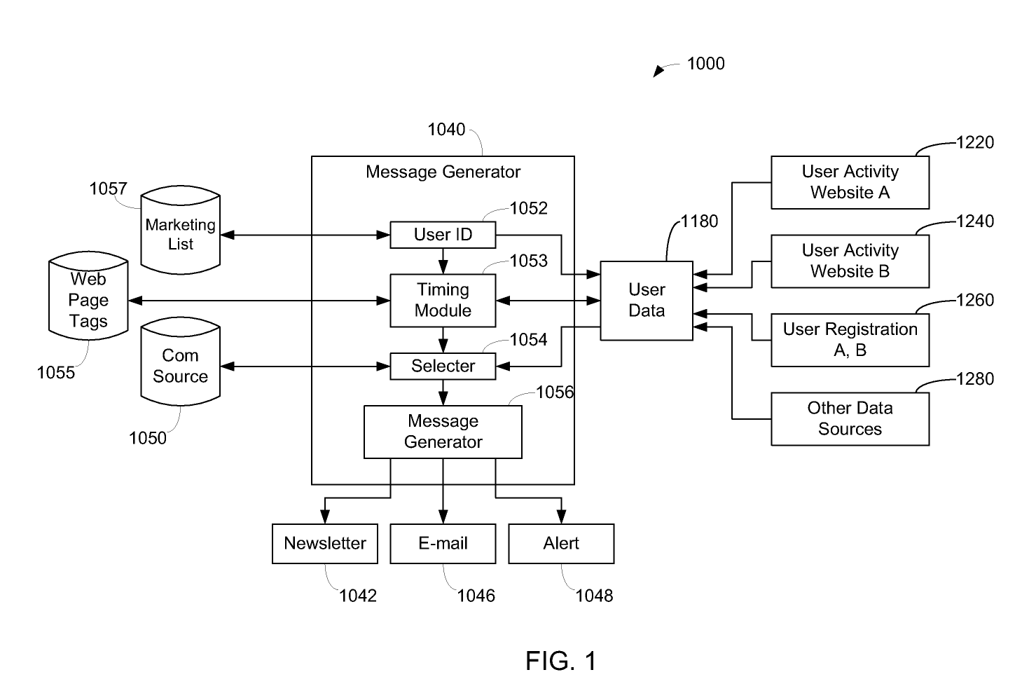

Referring first to FIG. 1, a system for providing an electronic message to a user during a browsing session will be described. The system may comprise an offer serving platform with one or more features of the platform described in U.S. application Ser. No. 13/221,708, filed Aug. 30, 2011, which is incorporated herein by reference in its entirety. Platform 1000 comprises a message generator 1040. Message generator 1040 comprises a timing module 1053 and a selector 1054. Timing module 1053 is configured to determine when it is time to send a message to a user based on user activity from user data source 1180. Selector 1054 is triggered by timing module 1053 to select a message based on data about the user from user data source 1180 and transmit the message to the message formatter 1056 for transmission to a user. Each module will now be described in greater detail.

Message generator 1040 is a module configured to generate the message (e.g., a newsletter 1042, an e-mail 1046, an alert 1048, etc.). Message generator 1040 is programmed to generate a message for a particular user, the user represented by a user ID 1052, by pulling message contents from communications source 1050 using a message content selector 1054.

User data source or interface 1180 may use information about a user's behavior on one or more websites and the tags associated with the content interacted with by the user (e.g., a pageview) to build a profile of user activity. The profile is then compared to offers available for that web site and a relevant and targeted offer newsletter is generated and sent to the user. User data source or interface 1180 is configured to receive data about a user from user activity on one or more websites 1220, 1240, etc., user registration data for one or more websites 1260, or other sources of user data 1280. For example, user data may be retrieved from a user profile database such as that described in U.S. patent application Ser. No. 13/023,377 filed Feb. 8, 2011 entitled “Targeting Offers to Users of A Website,” which is incorporated by reference herein in its entirety. As another example, user data may be retrieved from a user data store such as that described in U.S. patent application Ser. No. 13/093,658 filed Apr. 25, 2011 entitled “User Data Store,” which is incorporated by reference herein in its entirety. According to one example, a user activity source may be configured to generate a running stream of data about user interactions with a website, such as pageviews, clicks on content items, clicks for “more” content within an article, pauses on a page for a predetermined time period, and other interactions.

Communication source 1050 stores content for the messages to be communicated to the users. The content may comprise newsletters, offers such as advertisements, contests or coupons, white papers and/or other message content relating to the content on the websites. The websites may comprise product information web sites or other content-based web sites of different types (gaming content, sports content, news content, business content, etc.), such as www.cnet.com, www.bnet.com, www.cbssports.com, www.gamespot.com, etc. The offers may comprise links to product offer websites, etc., which may be a price comparison website such as www.shopping.com, or other merchant websites configured to sell or link to web sites selling products. The offer data may further comprise one or more of product name, product description, offer URL, price of offer, merchant name, merchant rating, an image of the product, etc., and may be provided in XML format.

Timing module 1053 is configured to time the delivery of an electronic message to a user. Timing module 1053 may be configured to determine based on the user interaction data from user data 1180 that the user has had a predetermined number or threshold of interactions (e.g., views of different pages) with the web site before transmitting the electronic message over the network interface to the user. For example, timing module 1053 may be configured to determine that a user has had at least five, at least 10, or at least 15 interactions, such as pageviews, before triggering selecter 1054 to select a message and message formatter 1056 to format and send a message. The predetermined threshold of interactions may be coupled with a predetermined time period, such as at least five pageviews in an hour, in ten minutes, in a half hour, in eight hours, in 24 hours, etc.

Timing module 1053 may further be configured to identify a keyword associated with the content viewed by the user, e.g., by querying a database of tags associated with web pages viewed by the user, and to receive from the database a tag common to at least a predetermined number of the web pages viewed by the user. For example, if five pages have been viewed during a browsing session or in a predetermined period of time and at least three of those pages have the tag “tablet computers” associated therewith, a keyword of “table computers” will be used to select content for an electronic message for a user. On the other hand, if there are no tags common to the five pages visited, then no keyword will be used to select a message and no message may be sent (or a generic message may be sent). A database of web page tags 1055 may be maintained for use by timing module 1053 to identify tags for pages visited by a user (as determined from user data 1180). Database 1055 may further be configured to receive and store information relating to a browsing session of a user for use in determining whether a user is still browsing, when a user typically browses, which pages are browsed, etc.

Timing module 1053 may be configured to select and send a targeted message to a user while the user is still in a browsing session, is still in the same browsing session that generated at least some of the user data used to target the content to the user, or otherwise in real time. Timing module 1053 may be configured to send a message to the user immediately after or shortly after an Nth web page is visited, wherein N may represent the predetermined number of web pages to be visited and/or the predetermined number of web pages having a common tag that were visited. For example, in various embodiments, the message may be sent within one second, within three seconds, within 10 seconds, within 30 seconds, within one minute or within five minutes of the user reaching the Nth web page visited or otherwise interacted with. In another embodiment,

Message formatter 1056 is a module configured to receive message data from selector 1054 and triggered by timing module 1053 and to format the message for sending to a user, for example as a newsletter 1042, email 1046, and/or alert 1048, any of which may comprise an offer as part of the content of the message. Message formatter 1056 may comprise a network interface, which may include any mechanical components and/or electrical circuitry configured to connect the computer system embodying message formatter 1056 to a computer network, such as a local area network in communication with a wide area network, such as the Internet.

In operation, a computer system determines that a message is to be generated, for example as part of a messaging campaign, periodic update, etc. A list of user IDs of users who have signed up for or opted-in to receipt of the message is provided from a marketing list database 1057 to message generator 1040 at block 1052. Users may opt out by normal opt out methods of one or more lists. The list may be updated from time to time to add a new user interested in receiving electronic messages and remove an old user no longer interested in receiving electronic messages. A plurality of different marketing lists may be maintained for different brands or websites. For each user ID, timing module 1053 monitors website activity or interactions of the user to determine when a message should be sent. When a message should be sent, selector 1054 selects a message from communication source 1050, which may further be targeted to a user based on user data 1180. The message is formatted by message formatter 1056 and transmitted to the user in one or more formats, such as a newsletter (which may be emailed, posted, etc.), e-mail message, alert, etc.

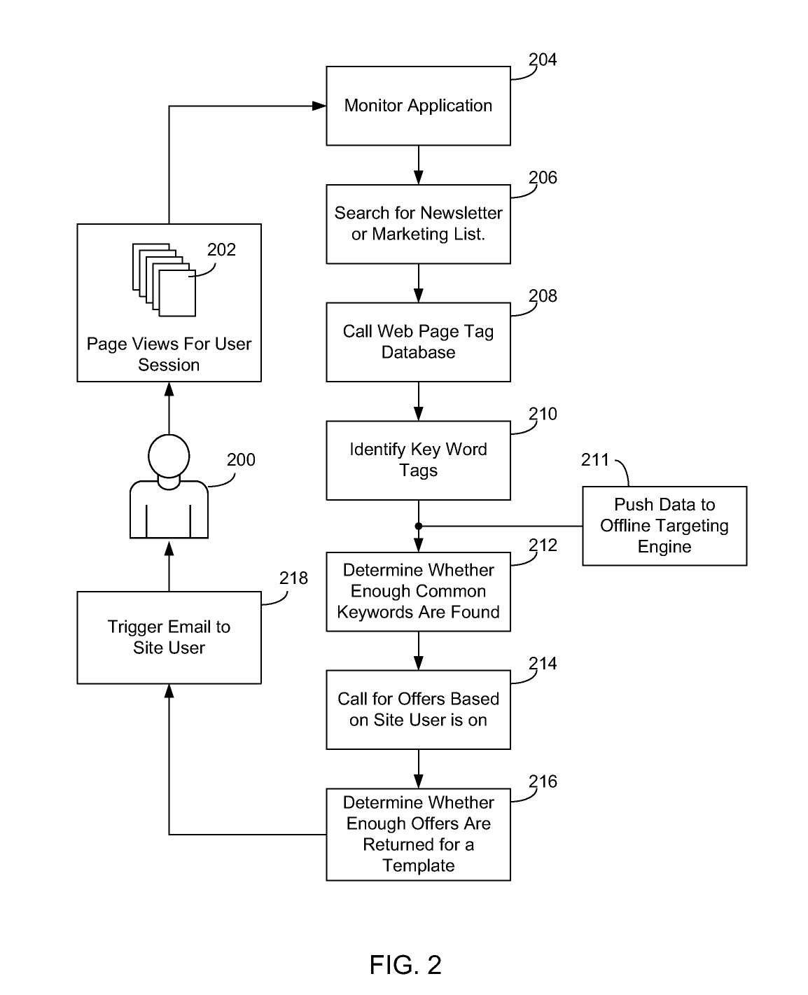

Referring now to FIG. 2, a flow diagram of an exemplary system for generating electronic messages for users will be described. A site user 200 interacts with a content on a web site during a user session and accumulates a plurality of page views 202. The session may be a web browsing session, which may represent a single continuous visit of multiple web pages, a visit of multiple web pages separated by small gaps in time (e.g., on the order of minutes or tens of minutes), or a visit of multiple web pages separated by longer periods of time, though typically not longer than a one day separation between web page visits. A web service monitors the web page visits and sends out metadata about the visits (e.g., URL, time of day, cookie, geographic location, etc.) in a live stream of data about events. A monitor application 204 is configured to read interaction data output by the web service. At block 206, if a user ID on a particular list of user IDs, such as a newsletter list or marketing list, is found, a web site tag database may be called (block 208) to identify one or more key word tags about the web pages visited by the user (block 210). The user list may comprise user IDs, messaging addresses (e.g., an email address, mobile phone number for text, or other messaging address). As mentioned, monitor application 204 may be configured to wait for a predetermined number or threshold of web site visits on a particular web site or collection of web sites before calling the web page tag database and proceeding with steps 208 and 210.

At block 212, the system may be configured to determine whether enough common keywords are found among the key word tags returned in block 210. If so, at block 214, the system is configured to make a call for second content, which may comprise offers, newsletters, or other content. The second content may be selected based on the key word tags returned in block 212 and, preferably, using the common keywords found in optional block 212. The offers may be internal to the web site, external or third party offers for other web sites or merchants. The offers may be further targeted to users using the platform described in U.S. application Ser. No. 13/221,708, filed Aug. 30, 2011. The second call may be made to different databases or web sites based on the web site that is subject to the user's current browsing session or the web site having the visits that triggered the call. For example, the system may be configured to determine that the web page views came from a product review website, such as www.cnet.com, in which case the call could be made to a merchant web site, such as www.shopper.com. The system may be configured to determine that the web page views came from a business content web site, such as www.bnet.com, in which case the call may be made to an internal engine to get a list of lead generation opportunities. The system may be configured to determine that the web page views came from a gaming web site, such as www.gamespot.com, in which case a gaming offers database would be called. The system may be configured to send keywords to the gaming offers database and to receive in response offers relating to particular games.

At block 216, if enough offers are returned for a template, the message is triggered (block 218) and sent to the site user 200, preferably while the site user is still on a web page used to select the offers, or at least while a user is still in a browsing session that included the web page used to select the offers, or otherwise in real time. For example, a template may be configured to hold a predetermined number of offers. If the system only receives one offer and the template requires two, then the system will not send the offer. If the template only requires one offer then the system will send it. If the system receives no offers that match the query, the system will not send the offer.

According to one embodiment, a limit module may be configured to limit the number of messages sent to a particular user to X per week, per day, etc. The limit module would prevent a new message from being sent from the computer system described in FIGS. 1 and 2 if the limit has already been reached for messages to be sent to the user in the particular time period. The system may further be configured to track by cookie ID or obid when a message is sent to make sure the system does not send the same message twice or multiple messages in short succession, if that is desired.

In one embodiment, a user who has been research an HP laptop computer on a product information/evaluation/opinion web site can be sent an email about the product while the user is browsing web pages about the product. The message could be configured for engaging the user further with the website.

In another embodiment, a user who has been viewing videos and web pages about games on a gaming web site of a particular type (e.g., first party shooter games) may be offered by electronic message a download and/or offer to buy, for example with a offer for a discount.

In another embodiment, the targeting of content to a user can be accomplished with a matching database configured to receive as inputs metadata about available content such as a white paper and a user profile and to generate as an output one or more content items suitable for the user or otherwise matching the user profile. The matching database may be configured to implement part or all of a lead generation marketing tool. Lead generation can be a tool to generate consumer interest or inquiry into products or services of a business. Leads can be generated for list building, e-newsletter list acquisition, etc. The matching database may be configured to track a number of qualified leads provided to a marketer associated with a content piece and to credit or debit an account (e.g., an account associated with the web site operator can be credited) based on the number of qualified leads who have been sent the content piece. For example, the matching database may be configured to take data from a user profile, such as an industry, job title, interests, etc. of a user and identify whether this use profile matches the definition of a qualified user for a content piece.

In another embodiment, as shown by block 211 of FIG. 2, the pageview information and keywords obtained from common pageviews during a browsing session may be provided as inputs to a user data store for additional targeted offers to a user, such as that described in U.S. patent application Ser. No. 13/093,658 filed Apr. 25, 2011 entitled “User Data Store,” which is incorporated by reference herein in its entirety. The data obtained in the embodiments described herein may also be provided to a user profile database for additional targeted offers to a user such as that described in U.S. patent application Ser. No. 13/023,377 filed Feb. 8, 2011 entitled “Targeting Offers to Users of A Website,” which is incorporated by reference herein in its entirety. For example, the pageview information can be used to put a user in a particular bucket or marketing segment to be used for other types of offer promotions.

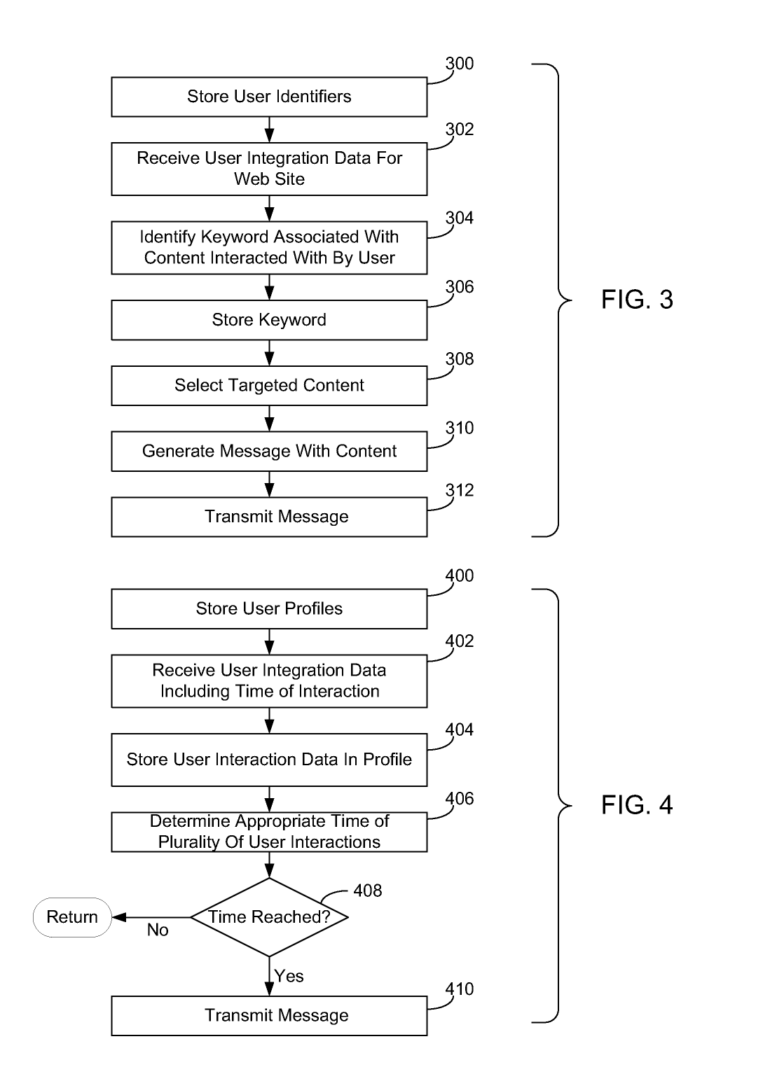

Referring now to FIG. 3, a flowchart of a method of generating a message for a user according to an exemplary embodiment will be described. At block 300, the method comprises storing in a memory a plurality of user identifiers, wherein each user identifier comprises an electronic message address associated with the user. At block 302, the method comprises receiving user interaction data relating to user interaction with first content on a web site during a web browsing session. At block 304, the method comprises identifying a keyword associated with the content interacted with by the user. The keyword may be identified by loading tags associated with the web page or content thereon. At block 306, the method comprises storing the keyword in a memory device. At block 308, the method comprises selecting second content using the stored keyword. The keyword may be used as an input to a content selection device configured to match or approximately match the keyword to tags or other metadata associated with a plurality of items of content, in order to identify content relevant to or targeted to the user. At block 310, the method comprises generating an electronic message comprising the second content. At block 312, the method comprises transmitting the electronic message over a network interface to the user during the web browsing session.

Referring now to FIG. 4, a flowchart of a method for generating a message for a user will be described, according to another embodiment. In this embodiment, the computer system records times a user has previously visited one or more web sites or pages thereon and makes a prediction of sorts that the user will again be on the same sites or pages at the same time in the future. The system sends a message to the user at the time, which may be without regard to whether the system detects that the user is actually browsing at the time the message is being sent.

At block 400, the system is configured to store in a memory a plurality of user profiles, wherein each user profile comprises at least an electronic message address associated with the user. At block 402, the system is configured to receive user interaction data relating to user interaction with a web site, wherein each of a plurality of user interaction data comprises a time that the user interacted with the web site. The time may comprise a time of day, a day, a date, an hour of the day, a month, or any other representation of a time. At block 404, the system is configured to store the user interaction data in respective user profiles in the memory. The user profiles may be data structures or any other association of data stored in different places for a user. At block 406, the system is configured to determine an approximate time associated with a plurality of user interactions with the web site based on the stored user interaction data for a user. To make the system more robust, a plurality of user interactions with the web site may be used in the calculation of the time. For example, if the user interacts with the web site at 9:01, 9:02, 9:04 and 9:06 one day and 9:00, 9:03, 9:04 and 9:06 the next day, the system may be configured to determine an approximate time associated with the plurality of interactions in any number of ways, for example, by averaging the times together, by taking the first time or last time, or by applying another algorithm. At block 408, the system is configured to determine whether the approximate time has been reached. If not, the system returns to other processing. If the time has been reached, the system is configured to do one or more of generate and transmit an electronic message over a network interface to the user. One or more elements described in U.S. patent application Ser. No. 13/250,049 filed Sep. 30, 2011 titled “System And Method For Configuring Operations Of Communication Services,” which is incorporated herein by reference in its entirety, may be used in the embodiment of FIG. 4 or other embodiments herein.

Elements from the embodiments of FIGS. 1-3 may be incorporated into FIG. 4. For example, the FIG. 4 embodiment may further target content of the message based on content typically viewed by the user during the approximate times.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein.

The above-described embodiments can be implemented using hardware, software or a combination thereof. When implemented in software, the software code can be executed on any suitable processor or collection of processors, whether provided in a single computer system (“computer”) or distributed among multiple computers. The embodiments may be implemented on one or more processing circuits, which may programmed portions of one or more processors, implemented as programmed modules, objects, elements, portions, or devices being programmed to perform the functions recited herein.

Further, it should be appreciated that a computer may be embodied in any of a number of forms, such as a rack-mounted computer, a desktop computer, a laptop computer, a server computer, a cloud-based computing environment, a tablet computer, etc. Additionally, a computer may be embedded in a device not generally regarded as a computer but with suitable processing capabilities, including a Personal Digital Assistant (PDA), a smart phone or any other suitable portable or fixed electronic device.

The various methods or processes outlined herein may be coded and executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above. The recitation of a module, logic, unit, or circuit configured to perform a function includes discrete electronic and/or programmed microprocessor portions configured to carry out the functions. For example, different modules or unit that perform functions may be embodied as portions of memory and/or a microprocessor programmed to perform the functions.

Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

The indefinite articles “a” and “an,” as used herein in the specification and in the claims, unless clearly indicated to the contrary, should be understood to mean “at least one.”

While specific embodiments have been disclosed, the various embodiments are not to be considered limiting. One of ordinary skill in the art will understand that variations and modifications flow from the teachings provided herein.

1. A computer system for generating an electronic message for a user, the system comprising:
a memory configured to store a plurality of user identifiers, wherein each user identifier comprises an electronic message address associated with the user; and
a processing circuit configured to:
receive user interaction data relating to user interaction with first content on a web site during a web browsing session;
identify a keyword associated with the content interacted with by the user by querying a database of tags associated with web pages viewed by the user;
receive from the database a tag common to at least a predetermined number of the web pages viewed by the user;
store the keyword in a memory device;
select second content using the stored keyword;
generate an electronic message comprising the second content; and
transmit the electronic message over a network interface to the user during the web browsing session.

2. The computer system of claim 1, wherein the processing circuit is further configured to determine, based on the user interaction data that the user has had a predetermined number of interactions with the web site before transmitting the electronic message over the network interface to the user.

3. The computer system of claim 2, wherein the predetermined number of interactions comprises a predetermined number of views of different web pages on the web site.

4. (canceled)

5. The computer system of claim 1, wherein the first content on the web site comprises product information for a product, wherein the second content is related to the product and comprises at least one of an offer and product information.

6. The computer system of claim 1, wherein selecting the second content comprises selecting based on user profile criteria indicating that the user is a qualified lead for the second content.

7. The computer system of claim 1, wherein the selected second content comprises an offer relating to a video gaming product.

8. The computer system of claim 1, wherein the computer system operates to transmit the message in real time.

9. The computer system of claim 1, wherein the processing circuit is further configured to:
update the list of user identifiers in the memory to add a new user interested in receiving electronic messages; and
remove an old user no longer interested in receiving electronic messages.

10. The computer system of claim 1, wherein the processing circuit is further configured to select the second content based on a web site being visited by the user during the browsing session.

11. A computer system for generating an electronic message for a user, the system comprising:
a memory configured to store a plurality of user profiles, wherein each user profile comprises at least an electronic message address associated with the user; and
a processing circuit configured to:
receive user interaction data relating to user interaction with a web site, wherein each of a plurality of user interaction data comprises a time of day, a day, a date, or a month that the user interacted with the web site;
store the user interaction data in respective user profiles in the memory;
determine an approximate time associated with a plurality of user interactions with the web site based on the stored user interaction data for a user;
determine whether the approximate time has been reached; and
transmit an electronic message over a network interface to the user at the approximate time when the time has been reached.

12. The computer system of claim 11, wherein the approximate time comprises at least one of a time of day and a date.

13. The computer system of claim 11, wherein determining an approximate time associated with the plurality of user interactions comprises determining that the user viewed a web page on the web site on at least a predetermined number of occasions at approximately the same time of day.

14. The computer system of claim 13, the processing circuit further configured to:
select content for the electronic message based on tags associated with content viewed by the user during the predetermined number of occasions.

15. The computer system of claim 14, wherein the approximate time is no greater than an hour away from at least a plurality of the associated plurality of user interactions with the web site.

16. A non-transitory computer-readable storage medium comprising machine-executable instructions which, when executed by a processing circuit, implement a method comprising:
storing in a memory a plurality of user identifiers, wherein each user identifier comprises an electronic message address associated with the user;
receiving user interaction data relating to user interaction with first content on a web site during a web browsing session;
identifying a keyword associated with the content interacted with by the user by querying a database of tags associated with web pages viewed by the user;
receiving from the database a tag common to at least a predetermined number of the web pages viewed by the user;
storing the keyword in a memory device;
selecting second content using the stored keyword;
generating an electronic message comprising the second content; and
transmitting the electronic message over a network interface to the user during the web browsing session.

17. The computer-readable storage medium of claim 16, wherein the method further comprises:
determining based on the user interaction data that the user has had a predetermined number of interactions with the web site before transmitting the electronic message over the network interface to the user.

18. The computer-readable storage medium of claim 17, wherein the predetermined number of interactions comprises a predetermined number of views of different web pages on the web site.

19. (canceled)

20. The computer-readable storage medium of claim 16, wherein the first content on the web site comprises product information for a product, wherein the second content is related to the product and comprises at least one of an offer and product information.

21. The computer-readable storage medium of claim 16, wherein the method further comprises:
updating the list of user identifiers in the memory to add a new user interested in receiving electronic messages; and
removing an old user no longer interested in receiving electronic messages.
